(19) United States
(12) Patent Application Publication
(10) Pub. No.: US 2012/0040302 A1
(43) Pub. Date: Feb. 16, 2012

(54) Self-ligating non-metalic orthodontic bracket

(76) Inventor: Shannon Rogers, Rocklin, CA (US)

(21) Appl. No.: 12/925,806

(22) Filed: Oct. 29, 2010

Related U.S. Application Data
(60) Provisional application No. 61/280,182, filed on Oct. 29, 2009.

(51) Int. Cl. A61C 7/30

(52) U.S. Cl. 433/11; 433/24

(57) ABSTRACT

The orthodontic bracket includes a base surface mountable to a tooth and with a primary channel formed in an outer surface opposite the base surface. The primary channel is configured to receive an arch wire therein. An axle support such as a tube is located within a lower groove within the primary channel. A retainer clip has an axle residing within the tube. Arms join the axle of the retainer clip to a latch bar. The retainer clip can pivot between an open and closed position, with the latch bar securing the retainer clip in a closed position overlying the arch wire and holding the arch wire within the primary channel. The tube is hidden beneath the arch wire. Alternative axle supports include bores formed in the unitary mass of material forming the bracket with such bores spaced from the primary channel.

### CROSS-REFERENCE TO RELATED APPLICATIONS

This application claims benefit under Title 35, United States Code §119(e) of U.S. Provisional Application No. 61/280,182 filed on Oct. 29, 2009.

### FIELD OF THE INVENTION

The following invention relates to orthodontic brackets, and in particular self-ligating orthodontic brackets which hold an arch wire adjacent thereto.

### BACKGROUND OF THE INVENTION

The science of orthodontics relies on a variety of different appliances for applying forces to the teeth to move them to more optimal positions. One common orthodontic appliance is known as a bracket. Multiple brackets are typically bonded temporarily to surfaces of the teeth. Wires, often including an “arch wire,” pass adjacent the multiple brackets, typically through channels in the brackets. Ends of the arch wire are anchored to some of the teeth and the arch wire can be tensioned to increase tension on the arch wire and apply forces to the teeth adjacent to the brackets and arch wire.

To keep the arch wire or other wire within the channel of the bracket, or otherwise adjacent the bracket, some brackets, known as self-ligating brackets, include fasteners for capturing the arch wire adjacent the brackets and within the channel of the bracket or otherwise adjacent the bracket. Such fasteners, often called clips, are known in the prior art which are coupled to the bracket and capture the arch wire to the bracket. U.S. Pat. No. 7,585,171 is directed to an orthodontic bracket with rotary ligating cover which is illustrative of one form of self-ligating bracket known in the prior art. U.S. Pat. No. 7,192,274 teaches a ceramic orthodontic appliance with arch wire slot liner which liner acts as a form of ligating cover for holding the arch wire to the bracket. Beneficially, such clips or other fasteners allow the arch wire to slide relative to the bracket but keep the arch wire from popping out of the channel or otherwise translating away from the bracket. U.S. Pat. Nos. 7,585,171 and 7,192,274 are incorporated by reference herein in their entirety.

Often an important consideration in the wearing of orthodontic appliances is that the appearance of the appliance wearer not be excessively negatively impacted by the wearing of the brackets or other orthodontic appliances associated with the brackets. One technique for minimizing the appearance of the brackets is to form them out of transparent or translucent materials, or out of materials which are generally a similar color as the teeth. Such brackets can be formed of plastic or can be formed of other materials. One material often utilized is sapphire (aluminum oxide), also referred to as mono-crystalline brackets. Various different forms of aluminum oxide including sapphire can beneficially be utilized. A problem with many brackets having such a desirable non-metallic appearance is that ligating techniques for self-ligating brackets are not generally effective when formed of the rigid and brittle materials such as those forming mono-crystalline brackets. While flexible metal clips can conceivably be utilized to hold the arch wire adjacent the bracket, such metallic structures undermine the purpose of utilizing the mono-crystalline bracket material in the first place, namely minimizing the appearance of metal on the teeth of the wearer.

U.S. Pat. No. 7,192,274 illustrates one attempt at effectively holding the arch wire to a ceramic bracket while minimizing the utilization of metallic capturing materials. However, the complexity of this prior art ceramic self-ligating bracket as well as the potential for arch wire separation would benefit from improvement. Most particularly, the self-ligating bracket is preferably configured in such a way as to minimize the appearance of metal while also providing a secure anchoring of the arch wire to the bracket, preferably in a way that allows movement of the arch wire in direction relative to the bracket, but keeping the arch wire from translating entirely away from the bracket.

### SUMMARY OF THE INVENTION

With this invention a self-ligating bracket is provided which can hold an arch wire adjacent the bracket and capture the arch wire adjacent the bracket while still allowing the arch wire to slide relative to the bracket. FIGS. 1-3 reveal a preferred embodiment with FIGS. 1 and 2 depicting the arch wire in position adjacent the bracket (having been slid into a primary channel of the bracket along arrow A (FIG. 2)). In FIG. 1 a retainer clip has bee closed to secure the arch wire to the bracket. In FIG. 2 the retainer clip is shown during rotation (along arrow B) from an open position toward a closed position where a latch bar snaps over posts or is otherwise bent over posts to secure the retainer clip over the arch wire.

As best shown in FIG. 3, the entire retainer clip is allowed to rotate from an open position (FIGS. 2 and 3) to a closed position (FIG. 1). To allow such rotation, a portion of the retainer clip is in the form of an axle which passes through a tube. This tube resides within a groove at a bottom of the channel within the bracket. The tube can be formed of a metal material and will not be visible because it is directly behind the arch wire. The tube is hollow and the retainer clip has the axle preferably continuous through the tube to ensure that the retainer clip cannot be separated from the bracket and holds the arch wire to the bracket. Arms of the retainer clip extend from the axle and come together at a latch bar. This latch bar can pass over the posts, such as by snapping or by being bent around the posts, to hold the retainer clip to the bracket.

The retainer clip is preferably made of stainless steel and has dimensions and material properties (including an elastic limit and ultimate strength) associated with the material forming the retainer clip sufficient to hold the arch wire adjacent the bracket. In particular, either the retainer clip can be dimensioned so that forces applied thereto do not exceed the elastic limit thereof so that the stainless steel can snap resiliently with the latch bar snapping over the posts, or the elastic limit of the material forming the retainer clip can be exceeded but not the ultimate strength, so that the retainer clip does not break but is merely bent to pass over the posts and then is bent into position beneath the posts to hold the retainer clip to the bracket. With either technique, either associated with materials selected for the forming of the retainer clip, or by selection of a diameter for the material forming the retainer clip, effective attachment of the arch wire is achieved.

Other materials besides stainless steel could also be utilized for the retainer clip including titanium or titanium alloys, or other metals, preferably of a biocompatible nature. If generally non-biocompatible metals are utilized, the metals could conceivably be coated with a biocompatible coating. Any material currently in existence or developed in the future which has suitable strength and biocompatibility characteristics to function as the retainer clip could conceivably be utilized according to this invention.

While the bracket shown in FIGS. 1-3 is most preferred, brackets of a variety of different known geometries could be utilized according to this invention. Typically, such brackets have a channel into which the arch wire is placed. For brackets with such a channel, most preferably the tube is located in a groove at the bottom of the channel. If arch wires did not include such a channel, the tube could be otherwise formed or attached on any portion of the bracket. The tube, being formed of metal, is typically bonded to the bracket utilizing known techniques for bonding metals to ceramics. For instance, when the tube is formed of stainless steel and the bracket is formed of mono-crystalline aluminum oxide known bonding materials can be painted onto the tube and bracket interface and heated to cure the bonding agent and secure the tube to the bracket. While the bracket is shown with multiple posts on each side of the bracket, brackets having other configurations could also be utilized.

In FIGS. 4 and 5 two alternative bracket configurations are shown. In FIG. 4, a second alternative bracket is shown which differs from the embodiment of FIGS. 1-3 in that rather than placing the slot below the channel and utilizing a tube through which the axle passes, a bore is formed in the bracket and the axle passes through this bore in the bracket. This bore could go entirely through the bracket or could be a blind bore stopping short within the bracket. Most preferably, the retainer clip forms a continuous circuit to minimize the possibility of it becoming dislodged. As an alternative, the bore could be sufficiently deep but not entirely through the bracket and the axle could extend sufficiently far into the bore that displacement of the retainer clip axle from the bore is precluded.

In FIG. 5 an alternative bracket is depicted which has a bore passing entirely through the first alternative bracket. In this first alternative bracket, the bore is shown continuous through the first alternative bracket and the axle is shown continuous passing through this bore. Also, the position of the bore relative to the channel is somewhat different in FIG. 5 relative to FIG. 4. Other orientations for the bore or tube could be provided relative to the bracket with either an axle of the retainer clip passing entirely through the tube or with the axle terminating at ends within the tube or within a bore. In either event a pivoting joint is provided for coupling the retainer clip to the bracket in a manner allowing the retainer clip to rotate relative to the bracket between an open position and a closed position. In the closed position the arch wire is effectively captured adjacent the bracket while allowing the arch wire to slide relative to the bracket.

### OBJECTS OF THE INVENTION

Accordingly, a primary object of the present invention is to provide an orthodontic bracket which includes a retainer clip for retaining an arch wire adjacent the orthodontic bracket.

Another object of the present invention is to provide an orthodontic bracket of a self-ligating nature.

Another object of the present invention is to provide a method for holding an arch wire adjacent an orthodontic bracket.

Another object of the present invention is to provide a non-metallic orthodontic bracket which is self-ligating in nature.

Another object of the present invention is to provide a non-metallic orthodontic bracket which includes a retainer clip for holding an arch wire adjacent the non-metallic orthodontic bracket.

Another object of the present invention is to provide a low visibility orthodontic bracket.

Another object of the present invention is to provide a low visibility non-metallic orthodontic bracket with metallic portions hidden behind an arch wire path.

Another object of the present invention is to provide an orthodontic bracket which lends itself to ready manufacture utilizing known techniques.

Other further objects of the present invention will become apparent from a careful reading of the included drawing figures, the claims and detailed description of the invention.

### BRIEF DESCRIPTION OF THE DRAWINGS

FIG. 1 is a perspective view of an orthodontic bracket according to a preferred form of this invention with a retainer clip thereof in a closed position holding an arch wire along an arch wire path within a primary groove of the bracket.

FIG. 2 is a perspective view similar to that which is shown in FIG. 1 but with the retainer clip in an open position.

FIG. 3 is a perspective view of the orthodontic bracket of FIG. 1 shown without the arch wire and with the retainer clip in an open position.

FIG. 4 is a perspective view of an alternative embodiment of that which is shown in FIG. 1 and from a reverse point of view and with a retainer clip thereof shown in a closed position.

FIG. 5 is a perspective view of a second alternative bracket to that which is shown in FIG. 1 with a retainer clip shown in a closed position.

### DESCRIPTION OF THE PREFERRED EMBODIMENT

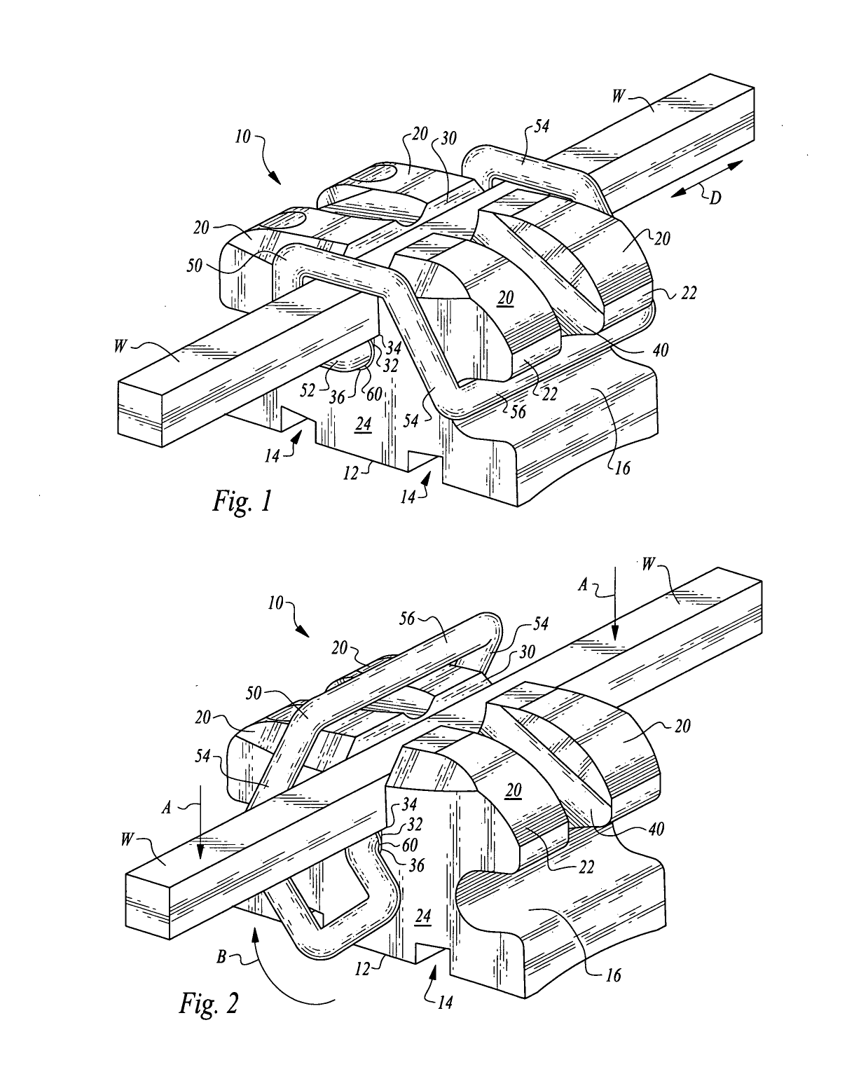

Referring to the drawings, wherein like reference numerals represent like parts throughout the various drawing figures, reference numeral 10 (FIG. 1) is directed to a bracket for attachment to a tooth surface for use in orthodontic procedures including holding of an arch wire W in a desired position adjacent the tooth and adjacent teeth. The bracket 10 is of a type which is self-ligating in that it is itself configured with a retainer clip 50 for holding the arch wire W along an arch wire path adjacent to the bracket 10. Many features of the bracket 10 are particularly configured for use when the bracket 10 is formed of a non-metallic material, such as a ceramic material, and particularly for instance aluminum oxide.

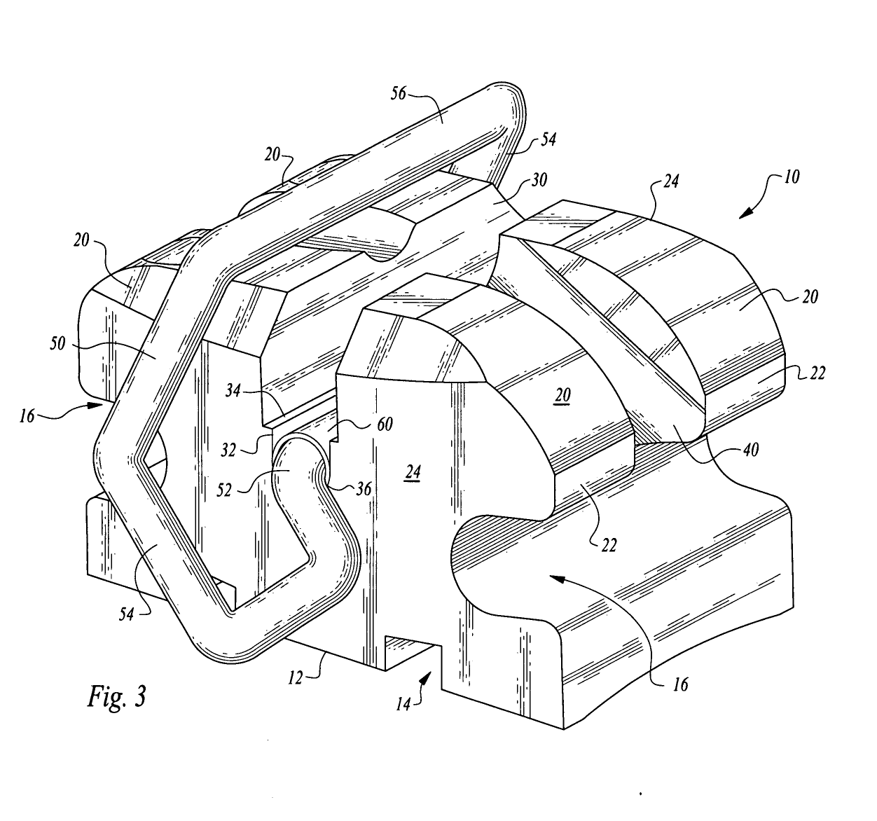

In essence, and with particular reference to FIG. 3, basic details of the bracket 10 are described according to a most preferred embodiment. The bracket 10 is a unitary mass of material extending from a base surface 12 to an outer surface opposite the base surface 12. The bracket 10 includes at least one post 20, and preferably a plurality of posts 20 extending from sides of the bracket 10 which are generally oriented facing vertically upward and downward when the bracket 10 is mounted on a tooth outer surface. Side surfaces of the bracket 10 are preferably defined by end walls 24.

A primary channel 30 extends into the outer surface and between the pair of end walls toward the base surface 12. This primary channel 30 is sized to receive an arch wire W therein (FIG. 1). A secondary channel 40 can optionally be provided intersecting the primary channel 30 and defining a space between multiple posts 20.

A retainer clip 50 is pivotably attached to the unitary mass of material forming the bracket 10. The retainer clip 50 includes an axle 52 which interfaces with an axle support, preferably in the form of a tube 60. The retainer clip 50 also includes arms 54 extending from the axle 52 and preferably joined together by a latch bar 56. The tube 60 preferably resides within a lower groove 32 within a portion of the primary channel 30 spaced from the outer surface of the bracket 10. The retainer clip 50 can thus move between an open position and a closed position to selectively secure the arch wire within the primary channel 30 and along the arch wire path.

More specifically, and with continuing reference to FIG. 3, details of the unitary mass of material forming the bracket 10 are described, according to this most preferred embodiment. The unitary mass of material can be formed of a variety of different materials and is preferably a solid mass of a single homogenous material. In a preferred form of this invention the material is ceramic and most preferably aluminum oxide in a particular composition and in a substantially mono-crystalline form which can be characterized as sapphire. In such a form, the bracket 10 can be at least partially translucent and hence less noticeable when mounted to teeth. The ceramic material could also be poly-crystalline. As an alternative, the unitary mass of material could be some other material (e.g. metal or plastic) and still function according to this invention. Material suitable for forming the bracket 10 include those materials known in the prior art and in the future developed suitable for use as orthodontic bracket material.

The unitary mass of material is preferably formed to have various different external features. A substantially planar base surface 12 defines a side of the bracket 10 configured for attachment to a surface of a tube. In particular, the base surface 12 is typically bonded to the tooth surface using some form of known orthodontic bracket 10 attachment adhesive. The base surface 12 can be entirely planar or slightly curved to more readily match the curvature of the tooth. Lower slots 14 are preferably provided in the base surface 12.

A pair of side channels 16 are preferably provided on upper and lower sides of the bracket 10 spaced a substantially constant distance away from the base surface 12 and at an intermediate location between the base surface 12 and the outer surface. These side channels 16 define one side of each post 20 to facilitate attachment of various different orthodontic structures to the post 20. These two side channels 16 can have a similar depth or can have varying depths. At least one of the side channels 16 can provide a further function of seating a latch bar 56 portion of the retainer clip 50 when the retainer clip 50 is in a closed position as described in detail below.

The embodiment of FIG. 3 shows the bracket 10 with four separate posts 20 above the side channel 16 and adjacent the outer surface of the bracket 10. These posts 20 are generally separated from each other by the primary channel 30 and the secondary channel 40. It is conceivable that there would be merely one post 20 above and below the primary channel 30 or more than two posts 20 could be provided on each side of the primary channel 30. The posts 20 generally include tips 22 at most distant portions of each post 20. The posts 20 are also bounded on lateral sides thereof by end walls 24 which define overall lateral sides of the bracket 10. The ends walls 24 are preferably substantially planar and parallel with each other, defining an overall width of the bracket 10. The end walls 24 could be non-parallel also.

With continuing reference primarily to FIG. 3, details of the primary channel 30 formed in the unitary mass of material of which the bracket 10 is comprised, as well as the secondary channel 40, are described according to a most preferred embodiment. The primary channel 30 provides a primary portion of an arch wire W path adjacent the bracket 10. This primary channel 30 preferably extends in a planar fashion with a constant width partially down into the outer surface and toward the base surface 12. This primary channel 30 has a width similar to a width of an arch wire W to be placed within the primary channel 30. The primary channel 30 can be lined, such as with a metal liner or a glass liner to reduce friction with the arch wire W.

Most preferably, the primary channel 30 includes a lower groove 32 in a lowermost portion of the primary channel 30. A step 34 provides a transition between a width of the primary channel 30 above the lower groove 32 and a width of the lower groove 32 itself. The lower groove 32 preferably has a curved floor 36. Such a curved floor 36 avoids stress concentrations at the bottom of the primary channel 30 and also maximizes availability of a bonding surface for bonding of the tube 60 to the bracket 10 with the tube 60 located within the lower groove 32. The floor could be contoured in a manner other than curved as well. The lower groove 32 extends below the primary channel 30 in a most preferred embodiment so the arch wire W can reside within the primary channel 30 above the lower groove 32. As an alternative, the lower groove 32 could extend up from the base surface 12, stopping just short of the primary channel 30 to position the tube 60 in a position close to where it is shown in FIG. 3.

A secondary channel 40 preferably is provided substantially perpendicular to the primary channel 30 and between the separate posts 20. The secondary channel 40 is provided to separate the posts 20 from each other. If a single post 20 is provided on each side of the primary channel 30, no secondary channel 40 would be needed. If more than two posts 20 are provided on each side of the primary channel 30, multiple secondary channels 40 would be provided. The secondary channel 40 can have various different depths, and preferably tapers to have a greater depth adjacent the tips 22 of the posts 20 than adjacent the primary channel 30.

With continuing reference primarily to FIG. 3, specific details of the retainer clip 50 are described, according to this most preferred embodiment. The retainer clip 50 is provided to secure (also referred to as “ligating”) the arch wire W adjacent the bracket 10 but allowing arch wire W sliding (along arrow D of FIG. 1). This retainer clip preferably is in the form of a wire of metallic material having an elongate substantially constant circular cross-sectional form. This retainer clip 50 includes an axle 52, arms 54 and a latch bar 56.

The axle 52 defines at least one linear portion of the retainer clip 50 preferably having a length slightly greater than a width of the bracket 10 between the pair of end walls 24. This axle 52 is preferably linear and with a diameter slightly less than a diameter of the tube 60 so that the axle 52 can reside within the tube 60.

A pair of arms 54 are preferably provided, with each arm 54 adjacent one of the end walls 24. As an alternative, conceivably a single arm 54 could be provided at only one end of the axle 52. Each arm 54 can have a variety of different configurations including continuously curving configurations or a series of linear struts spaced apart by angular bends. In a most preferred form of the invention shown in the figures, the arms 54 are provided with a series of struts of linear form spaced apart by right angle bends. A first short strut extends perpendicular to the axle 52 and joined to the axle 52 by a first bend. A second bend then transitions this first strut into a second strut perpendicular to the first strut. A third bend then transitions the second strut into a third strut. A fourth bend then transitions the third strut into a fourth strut. A fifth bend then transitions the fourth strut into the latch bar 56.

Preferably, each of the struts becomes progressively slightly longer. Preferably, each of the struts are oriented within a common plane perpendicular to the axle 52 and perpendicular to the latch bar 56, with the axle 52 and latch bar 56 generally parallel with each other. Each of the bends in the arms 54 preferably bend in a common direction so that the arms 54 tend to spiral out away from the axle 52 and towards the latch bar 56. The first and fifth bends bend the arms 54 out of the plane in which the arms 54 are formed and into the ends of the axle 52 and latch bar 56. The fourth bend is most preferably bent slightly less than 90°.

As an alternative, the arms 54 could continuously spiral between ends thereof from the axle 52 ends to the latch bar 56 ends. Other configurations in the arms 54 could also be provided which generally provide for connection between the axle 52 and the latch bar 56 and provide for clearance to allow the arch wire W to pass along the arch wire path aligned with the primary channel 30 (FIGS. 1 and 2). A single arm 54 could be provided alone, with or without the latch bar 56.

The latch bar 56 and axle 52 preferably each join the two arms 54 together. The latch bar 56 preferably is spaced from the axle 52 by a distance similar to a distance that the tips 22 of the posts 20 extend from the primary channel 30. By appropriately sizing the retainer clip 50, the latch bar 56 can just snap over the tips 22 of the posts 20 when rotated (along arrow B of FIG. 2) from the open position (FIG. 2) to the closed position (FIG. 1) where the latch bar 56 resides within the side channel 16.

The retainer clip 50 can be formed of a variety of different materials to function according to this invention. In one form of the invention the retainer clip 50 is formed of stainless steel. In other embodiments, the retainer clip 50 is formed of other metals or other materials and provided with a biocompatible coating. In another embodiment, the retainer clip 50 is formed of titanium or a titanium alloy.

Mechanical properties of the retainer clip 50 can be selected to allow the retainer clip 50 to plastically deform and bend over the tips 22 of the posts 20 and then plastically deform into a seated position within the side channels 16 below the posts 20. As another alternative, the retainer clip 50 can be formed of a material which can stretch elastically slightly to snap over the posts 20 without exceeding an elastic limit of the material forming the retainer clip 50.

As another alternative, the retainer clip 50 can be formed of a nickel titanium alloy having a transition temperature between a temperature dependent higher strength solid phase and a lower strength solid phase and with a shape memory. In such a shape memory configuration, the retainer clip 50 can be cooled into a lower strength phase such as by applying a coolant to the retainer clip to soften the retainer clip. The retainer clip 50 can then be readily snapped off of the posts 20 and out of the side channel 16, or vice versa. The transition temperature can be designed into the material so that at body temperatures the retainer clip 50 is in a higher strength phase so that the retainer clip 50 most completely resists undesired motion between the open and closed positions. when installed and positioned in use.

With continuing reference to FIG. 3, details of the tube 60 (defining a preferred form of axle support) is described according to a preferred embodiment of this invention. The tube 60 preferably has a hollow cylindrical shape with a constant circular cross-sectional form extending between ends and with a length similar to a distance between the two end walls 24. This tube 50 preferably has an outer curvature similar to that of the curved floor 36 of the lower groove 32 within the primary channel 30. As an alternative, the lower groove 32 could be formed on a lateral side of the primary channel 30 with the tube 60 still residing within such a lower groove 32 in such an alternative position. It is also conceivable that the tube 60 could merely be bonded within a lowermost portion of the primary channel 30 without providing the lower groove 32.

The tube 60 is preferably formed of a metal material, such as stainless steel, or other suitable material. The tube 60 is sized to receive the axle 52 therein to act as an axle support. The tube 60 would typically be formed of a material different than the material forming the unitary mass of the bracket 10, especially when the bracket 10 is a non-metallic bracket 10.

The tube 60 can be bonded to the bracket 10 within the lower groove 32, such as by using an adhesive suitable for bonding metal to ceramic. Other techniques for securing the tube 60 within the lower groove 32 or elsewhere include use of a frit (e.g. a glass powder that is fired to bond stainless steel or other metal to the ceramic); metallization (e.g. applying a coating to the ceramic to which the tube 60 can be brazed); or active metal brazing (e.g. where an appropriate flux material facilitates direct brazing of ceramic to metal).

Once attached to the bracket 10, the tube 60 provides an axle support to allow the retainer clip 50 to be pivotably attached to the bracket 10. This tube 60, being formed of metal, typically has a more conspicuous appearance, especially relative to an at least partially translucent or naturally colored orthodontic bracket 10. By positioning this tube 60 within the lower groove 30 in the bottom of the primary channel 30, the tube 60 hides beneath the arch wire W (FIGS. 1 and 2). Thus, this tube 60 is hidden and the overall impression of the bracket is that it is substantially invisible and only the arch wire and very small diameter retainer clip 50 can be seen.

The retainer clip 50 being a continuous loop, requires some special manipulation to install the retainer clip 50 within the tube 60 and adjacent the bracket 10. In one form of the invention, the axle 52 is split at a midpoint thereof with each axle segment snapped into opposite ends of the tube 60. As an alternative, the retainer clip 50 can be initially formed as a complete circuit, such as from a single piece of material, and then the tube 60 formed about the retainer clip 50 and then the tube 60 bonded to the bracket 10. As another alternative, some other portion of the retainer clip 50 can be opened, such as a midpoint of the latch bar 56, or at one of the bends or struts within one of the arms 54. The opening can then be welded or use a fastener or adhesive to be closed.

The retainer clip 50 can start as a linear section of wire routed through the tube 60 and then be appropriately bent to form the bends and struts until the entire configuration for the retainer clip 50 has been provided. As another alternative, the retainer clip 50 can be provided as two separate arms 54 which do not connect together but are positioned with separate axles 52 residing within ends of a common tube 60 to provide two separate retainer clips one adjacent each of the end walls 24. In such a configuration, the latch bar 56 could be eliminated. However, the latch bar 56 is preferred as it provides additional stability to the overall retainer clip 50 and secures the two arms 54 of the retainer clip 50 to discourage them from becoming displaced relative to the tube 60.

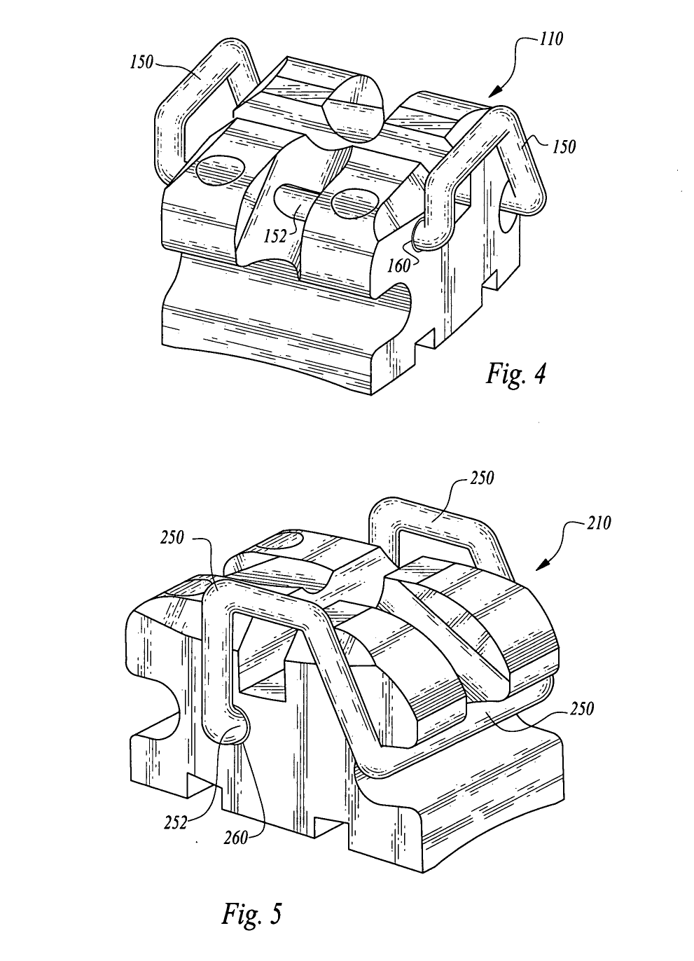

With particular reference to FIG. 4, details of an alternative embodiment bracket 110 are described. This alternative bracket 110 is similar to the bracket 10 of the preferred embodiment (FIGS. 1-3) except that the tube 60 is eliminated or provided with a separate location. In particular, a through-bore 160 (FIG. 4) is provided extending between the two end walls 24 (FIGS. 1-3) near the primary channel 30 but spaced from the primary channel 30. A tube 60 can be provided as a sleeve within this through-bore 160, or the tube 60 can be avoided. An axle 152 of the retainer clip 150 of this embodiment passes through the bore 160 rather than passing through the tube 60. Dimensions of the various struts and bends within the retainer clip 150 are appropriately modified to accommodate this new position for the bore 160 as an alternative axle support with the alternative bracket 110 of this embodiment. Other details of this alternative bracket 110 are similar to those described above with regard to the bracket 10 (FIGS. 1-3).

With particular reference to FIG. 5, a second alternative bracket 210 is described. This second alternative bracket 210 has two separate bore segments with each bore segment extending as a blind bore 260 into each of the end walls 24. Each blind bore 260 is preferably substantially collinear with the other. The alternative bracket 210 includes an alternative retainer clip 250. This alternative retainer clip 250 is preferably similar to the retainer clip 50 of the preferred embodiment (FIGS. 1-3) except that the axle 52 of the preferred embodiment is replaced with a pair of axle segments 252 (FIG. 5) which extend into each of the blind bores 260.

With particular reference to FIGS. 1 and 2, details of the use and operation of the bracket 10 of the preferred embodiment of this invention are described, in a method of securing the arch wire W adjacent the bracket 10. Initially, the bracket 10 is bonded to a surface of a tooth and the retainer clip 50 is positioned in an open configuration as depicted in FIG. 2. The arch wire W is then placed within the primary channel 30 by movement of the arch wire along arrow A of FIG. 2.

Next, the retainer clip 50 is rotated (about arrow B of FIG. 2) from the open position to the closed position. The retainer clip 50 is snapped or otherwise deformed over the posts 20 so that the latch bar 56 snaps into the side channel 16 (FIG. 1). The arch wire W is free to slide (along arrow D of FIG. 1) relative to the bracket 10 but is restrained from displacement away from the bracket 10.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1: A self-ligating orthodontic bracket, comprising in combination:
a unitary mass of material having a base surface adapted to be coupled to a surface of a tooth;
said unitary mass of material having an outer surface most distant from said base surface, said outer surface including a primary channel formed therein;
said unitary mass of material having a pair of end walls on opposite sides of said unitary mass of material and extending away from said base surface and toward said outer surface;
said primary channel sized and oriented to allow an arch wire to be placed therein and extending past said end walls;
a retainer clip, said retainer clip including an axle and at least one arm extending from said axle;
said axle pivotably attached to said unitary mass of material;
said axle extending past at least one of said end walls;
said retainer clip including at least one arm extending from said axle;
said arm having a closed position at least partially overlying an arch wire path aligned with said primary channel and an open position spaced from said closed position; and
said open position having less coverage of said arch wire path than said closed position.

2: The bracket of claim 1 wherein at least one axle support is provided, said axle support adapted to rotatably support said axle therein relative to said unitary mass of material.

3: The bracket of claim 2 wherein said at least one axle support includes a bore in said unitary mass of material extending into at least one of said end walls.

4: The bracket of claim 3 wherein a pair of blind bores are provided extending substantially collinearly into each of said end walls.

5: The bracket of claim 3 wherein said bore includes a through-bore extending entirely between said pair of end walls.

6: The bracket of claim 2 wherein said at least one axle support includes a tube in said primary channel, said tube sized to receive said axle therein.

7: The bracket of claim 6 wherein said primary channel includes a lower groove on a side of said primary channel most distant from said outer surface, said tube located within said lower groove.

8: The bracket of claim 7 wherein said lower groove has a curved floor and said tube is curved, with a curvature of said floor generally matching a curvature of said tube.

9: The bracket of claim 8 wherein a step is provided at a transition between said lower groove and other portions of said primary channel, said step defining a transition between said lower groove and other portions of said primary channel, with said lower groove having a width less than other portions of said primary channel.

10: The bracket of claim 1 wherein said retainer clip includes a pair of arms, each of said arms pivotably attached to opposite ones of said end walls.

11: The bracket of claim 10 wherein a latch bar extends between said arms on ends of said arms opposite said axle.

12: The bracket of claim 11 wherein said two arms are each joined to a separate axle segment, said axle segments aligned collinearly with each other.

13: The bracket of claim 11 wherein said two arms are each coupled to a common single axle joining said two arms together.

14: The bracket of claim 1 wherein said closed position of said retainer clip is rotatably spaced from said open position.

15: A method for holding an arch wire within a primary channel and arch wire path associated with an orthodontic bracket, the method including the steps of:
providing the bracket having a unitary mass of material having a base surface adapted to be coupled to a surface of a tooth, the unitary mass of material having an outer surface most distant from the base surface, the outer surface including a primary channel formed therein, the unitary mass of material having a pair of end walls on opposite sides of the unitary mass of material and extending away from the base surface and toward the outer surface, the primary channel sized and oriented to allow an arch wire to be placed therein and extending past the end walls, a retainer clip, the retainer clip including an axle and at least one arm extending from the axle, the axle pivotably attached to the unitary mass of material, the axle extending past at least one of the end walls, the retainer clip including at least one arm extending from the axle, the arm having a closed position at least partially overlying an arch wire path aligned with the primary channel and an open position spaced from the closed position and the open position having less coverage of the arch wire path than the closed position;
placing the arch wire along the arch wire path and at least partially within the primary channel; and
transitioning the retainer clip from the open position to the closed position.

16: The method of claim 15 including the further step of forming a bore into at least one of the end walls and locating the axle within the bore to allow the axle to be rotatably supported within the bore.

17: The method of claim 15 wherein the retainer clip includes at least two arms, each of the arms pivotably attached to opposite ones of the pair of end walls.

18: The method of claim 17 including the further steps of:
forming a pair of blind bores extending into opposite ones of the pair of end walls substantially collinear with each other;
forming the axle as a pair of axle segments substantially collinear with each other; and
placing the axle segments in the blind bores with one of the axle segments in each of the blind bores.

19: The method of claim 17 including the further steps of:
forming a through-bore extending between the pair of end walls;
providing said the axle as a through-axle with the arms coupled to opposite ends of the axle, and with the axle having a length greater than a length of the through-bore; and
placing the axle within the through-bore.

20: The method of claim 17 including the further steps of:
securing a tube to the unitary mass of material within the primary channel and spaced from the outer surface, the tube having open ends sized at least as large as the axle; and
placing the axle within the tube and extending out of at least one of the ends of the tube.
